(19) United States
(12) Patent Application Publication
(10) Pub. No.: US 2006/0179722 A1
(43) Pub. Date: Aug. 17, 2006

(54) Edge treatment for glass panes

(76) Inventor: Robert G. Spindler, Eden Prairie, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/345,581

(22) Filed: Feb. 1, 2006

Related U.S. Application Data
(60) Provisional application No. 60/649,293, filed on Feb. 2, 2005.

(51) Int. Cl. E06B 3/00

(52) U.S. Cl. 49/501

(57) ABSTRACT

The invention provides a glass pane having a central portion and a peripheral portion. The peripheral portion is heat-treated to increase its resistance to breakage and the central portion is not heat-treated. The glass pane is suitable for use as a window in a window frame. The invention also provides methods of forming a glass pane suitable for use as a window in a window frame.

### RELATED APPLICATION

The present application claims priority to U.S. provisional patent application 60/649,293, filed Feb. 2, 2005, the entire disclosure of which is incorporated herein by reference.

### FIELD OF THE INVENTION

The invention provides a glass pane that is resistant to thermal breakage. The invention also provides methods for making a pane resistant to thermal breakage.

### BACKGROUND OF THE INVENTION

Glass panes are commonly installed into window frames. When a glass pane is installed into a window frame, the periphery (or edges) of the glass is typically covered by the frame while the central is uncovered and exposed to sunlight. The exposed, central glass often absorbs the sunlight and other radiation, particularly when the glass substrate also carries a somewhat absorptive coating. This absorption of radiation causes the exposed central of the glass to heat up. Meanwhile, the edges of the glass pane are not heated up because they are within the frame and are not exposed to the sunlight.

This phenomenon can be understood by considering the glass temperatures on a cold winter morning. Before sunrise, a framed window may be at a uniform temperature of perhaps 30° F. As the sun rises, the glass pane exposed to the sun is rapidly heated at its center, but not at its shielded edges, to a temperature of perhaps 70° F. or more. When the central area of the glass pane is heated and the edges are not, a thermally induced tensile stress is built up along the edges of the glass. Tensile stress is undesirable because it can cause thermal breakage along these areas where warm glass meets cooler glass. Thermal breakage is also more likely to occur in glass areas that contain a flaw, i.e., a chip in the glass or like, as flaws tend to propagate under a tensile load.

Because of this buildup of tensile stress, glass manufacturers are commonly concerned that this tensile stress does not result in thermal breakage. Thermal breakage can occur when the tensile stresses exceed the strength of the glass. Thermal breakage can also arise from an imperfection (i.e., slight crack, chip or the like) in the edge of the glass. Under tensile stresses, a crack may propagate and quickly spread through the central portion of the glass pane and often to another edge. It is also possible that the crack will propagate around the periphery of the pane only. Thus, manufacturers often find it desirable to heat strengthen or temper the glass pane before installing it into a window frame. Traditionally, glass is strengthened by subjecting the entire pane of glass to a heat treatment.

Generally, a pane of glass may be strengthened by heating the glass pane to a temperature at which the glass begins to soften and then rapidly quenching the surfaces of the glass pane. This creates a temperature differential between the hot mid-plane of the glass and the cooler exterior surfaces, hereinafter “ΔT”. To strengthen the glass, the glass pane is generally heated to a temperature exceeding the glass transition temperature T_{g}. The term T_{g} refers generally to the approximate temperature at which a liquid transitions to a glassy state. The T_{g} of glass depends on the particular type of glass, but is typically about 983° F. The exterior surfaces of the glass are cooled to provide a substantial ΔT between the exterior glass surface and the mid-plane of the glass pane. For example, if a ΔT is to be 100 F°, the glass pane should be heated to at least 983° F. plus 100 F°, or 1083° F. before quenching. This technique creates compressive stress in the exterior surfaces of the glass, which results in a strengthened glass pane.

A simple explanation of the heat strengthening phenomenon follows: When the exterior surface of the glass pane is heated beyond its T_{g} and then cooled rapidly, the exterior surface tends to set up or solidify while glass at the mid-plane of the glass pane is still above the softening temperature of the glass. As glass at the interior cools; it contracts, and this causes the exterior surface of the glass to be placed in compression while the interior of the glass about the mid-plane is in tension. The compressive forces developed at the surface are balanced by the tensile forces along the mid-plane. For example, it may be estimated that after heat treatment, the inner 58% of the thickness of a glass pane will be in tension whereas the remaining outer 42% (21% measured inwardly from each surface) will be in compression. The compressive stresses are greatest at the surface of the glass pane and decrease inwardly.

One commonly used heat strengthening treatment is known as tempering. Tempering typically involves placing an entire pane of glass onto a set of horizontal rollers within a furnace. In some tempering processes, the glass is moved back and forth on these rollers during tempering. In other tempering processes, the glass is moved continuously through the furnace on ceramic rollers. One drawback seen with tempering and other heat treatments using rollers is that the rollers sometimes create “roll waves” in the glass. Roll waves are created when the glass becomes softened due to the heat and corrugations, dimpling, embossing or waviness is imparted on the softened glass by the rollers. These roll waves can be undesirable because they result in visible distortions in the final glass product. Thus, it would be desirable to have a method other than heat treating an entire glass pane to strengthen the glass pane so that the edges are resistant to thermal breakage.

### SUMMARY

The invention provides a glass pane having an central portion and a peripheral portion extending inwardly from and bounded by the edges of the glass pane. The peripheral portion is heat-treated to increase its resistance to breakage whereas the central portion is not heat-treated. The glass pane is suitable for use in a framed glass unit.

The invention also provides a framed glass unit comprising a glass pane and a frame. The glass pane has a central portion and a peripheral portion. The peripheral portion is heat-treated to increase its resistance to breakage whereas the central portion is not heat-treated. The frame shields at least part of the peripheral portion. In certain embodiments, the peripheral portion comprises the entire portion of the glass pane shielded by the frame. In other embodiments, the peripheral portion comprises the entire portion of the glass pane shielded by the frame and a portion of the glass pane not shielded by the frame. In yet other embodiments, the peripheral portion comprises a portion of the glass pane shielded by the frame but not the entire portion of the glass pane shielded by the frame.

The invention further provides a method for forming a glass pane suitable for use as a window. In certain embodiments, the method for forming a glass pane suitable for use as a window comprises providing a glass pane that has not been heat-treated, the glass pane having a peripheral portion and a central portion, heating the peripheral portion, causing the peripheral portion to heat up, and quenching the peripheral portion with a cold quenching medium to heat treat it, while leaving the central portion free of heat treatment.

In other embodiments, the method for forming a glass pane suitable for use as a window comprises providing glass that has not been heat-treated, cutting the glass into a pane having a peripheral portion and a central portion, the cutting causing the peripheral portion of the glass pane to heat up, and quenching the peripheral portion with a cold quenching medium to heat treat it, while leaving the central portion free of heat-treatment. Preferably, the glass is cut using a laser. In certain embodiments, the method further includes framing the resulting glass pane with a frame having a shielding portion extending inwardly from the pane edges.

The cold quenching medium is preferably either a cold air medium, a carbon dioxide medium, or a liquid nitrogen vapor medium. The quenching reduces the surface temperature of the peripheral portion sufficiently to provide a ΔT between the surface and the interior of the pane of at least about 10° F. Preferably, the quenching reduces the surface temperature of the peripheral portion sufficiently to provide a ΔT up to about 200° F. More preferably, the quenching reduces the surface temperature of the peripheral portion sufficiently to provide a ΔT in the range of about 70° F. to about 150° F.

### BRIEF DESCRIPTION OF THE DRAWINGS

FIG. 1 is a top view illustrating a glass pane in accordance with one embodiment of the invention;

FIG. 2 is a top view illustrating a framed glass unit in accordance with one embodiment of the invention;

FIG. 3 is a top view illustrating a framed glass unit in accordance with another embodiment of the invention;

FIG. 4 is a top view illustrating a framed glass unit in accordance with another embodiment, of the invention;

FIG. 5 is a cross-sectional side view illustrating the path of laser cutting of a glass pane in accordance with one embodiment of the invention;

FIG. 6 is a cross-sectional side view illustrating the path of laser cutting of a glass pane in accordance with another embodiment of the invention; and

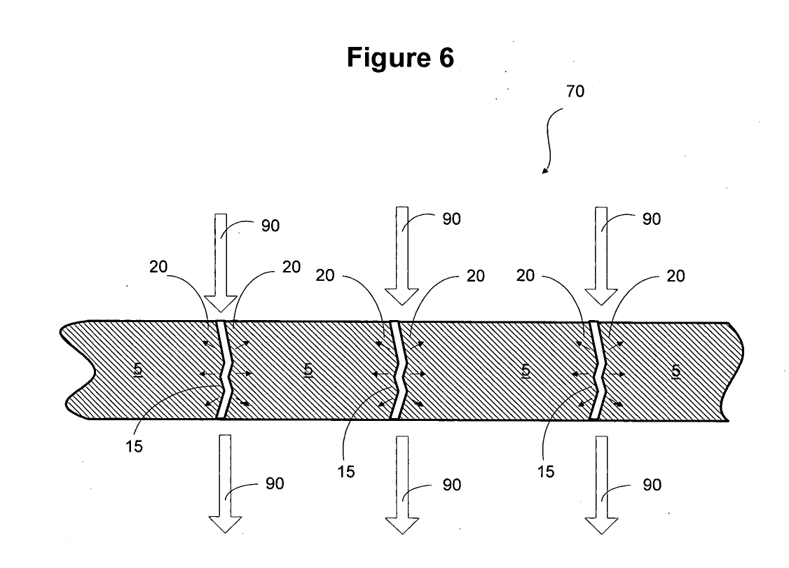

FIG. 7 is a perspective view illustrating an edge treatment apparatus in accordance with an embodiment of the invention.

### DETAILED DESCRIPTION OF PREFERRED EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

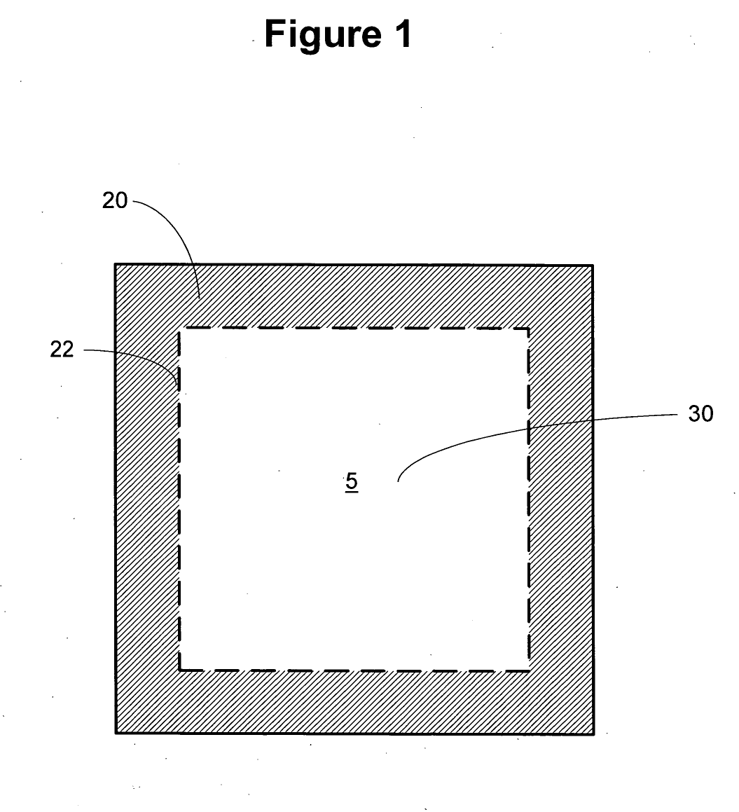

In certain embodiments, the invention provides a glass pane having a peripheral portion and a central portion, the peripheral portion being heat-treated to increase its resistance to breakage and the central portion being not heat-treated. Glass that is not heat-treated includes glass that substantially remains in its as produced annealed state. The central portion comprises the portion of the glass not including the peripheral portion, and accounts for the majority of the area of the glass pane. The peripheral portion is the portion of the glass that extends inwardly from and is bounded by the edges of the glass pane. An embodiment of this type is depicted in FIG. 1. FIG. 1 shows a glass pane 5 having a peripheral portion 20 and a central portion 30. Here, the central portion 30 is the portion of the glass pane inwardly from and surrounded by the outer peripheral portion 20.

The peripheral portion comprises heat-treated glass. The term “heat-treated glass” is used herein to refer to any glass portion that has been subjected to a heat treatment known in the art to strengthen glass. In certain embodiments, the peripheral portion is heat-treated so that its outer surface exhibits a compressive stress up to about 10,000 psi. In other embodiments, the peripheral portion is heat-treated so that its outer surface exhibits a compressive stress ranging from about 3,500 psi to about 10,000 psi. In preferred embodiments, the peripheral portion is heat-treated so that its outer surface exhibits a compressive stress ranging from about 3,500 psi to about 7,500 psi. The inventors have found that glass having a compressive stress up to about 3,500 psi generally resists thermal or bending breakage and glass having a compressive stress ranging from about 3,500 psi to about 10,000 psi generally substantially prevents thermal or bending breakage. Glass having a compressive stress above 10,000 psi also heat strengthens glass and are within the scope of the invention, but a compressive stress above 10,000 psi is not necessary as lower stress levels are sufficient to prevent thermal or bending breakage.

Glass that is heat-treated so that its outer surface exhibits a compressive stress up to about 10,000 psi is herein referred to as “heat-strengthened”. Glass that is heat-treated so that its outer surface exhibits a compressive stress ranging from about 10,000 psi to about 18,000 psi is herein referred to as “tempered”. A main difference between heat-strengthened glass and tempered glass involves the size of the glass fragments that are produced when the glass is broken. Broken heat-strengthened glass produces fairly large glass shards whereas broken tempered glass produces much smaller glass fragments that are usually not more than one square inch in area. The present invention is directed towards heat-strengthening the peripheral portion of a glass pane to prevent thermal or bending breakage.

In certain embodiments, the invention provides a framed glass unit comprising a glass pane and a frame, the glass pane having a peripheral portion that is heat-treated and having a central portion that is not heat-treated. The frame has a portion that extends inwardly and shields a portion of the pane. The peripheral portion of the pane is heat-treated whereas the central portion is not heat-treated. Again, in certain embodiments, the peripheral portion is heat-treated so that its outer surface exhibits a compressive stress up to about 10,000 psi. In other embodiments, the peripheral portion is heat-treated so that its outer surface exhibits a compressive stress of at least about 2,000 psi. In yet other embodiments, the peripheral portion is heat-treated so that its outer surface exhibits a compressive stress ranging from about 3,500 psi to about 10,000 psi. In preferred embodiments, the peripheral portion is heat-treated so that its outer surface exhibits a compressive stress ranging from about 3,500 psi to about 7,500 psi.

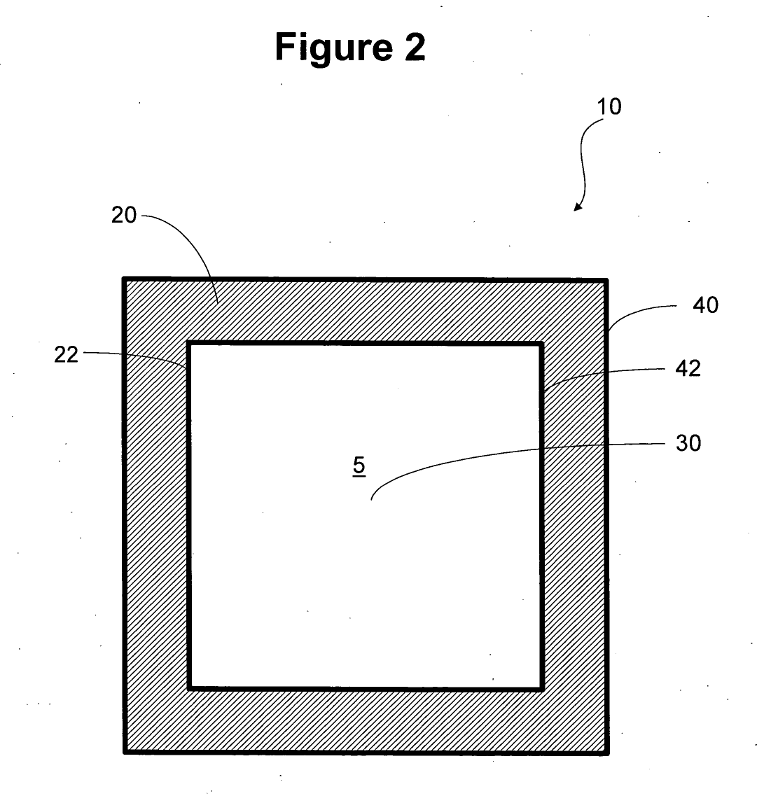

In certain embodiments, the peripheral portion is the portion of the glass pane that is shielded by a frame. An embodiment of this type is depicted in FIG. 2, which illustrates a framed glass unit 10 comprising a glass pane 5 and a frame 40. The frame 40 has an inner edge 42 (nearest the central portion 30). The glass pane 5 has a peripheral portion 20 that is heat-treated and a central portion 30 that is not heat-treated. The peripheral portion 20 also has an inner edge 22 (nearest the central portion 30). In the embodiment of FIG. 2, both the inner edge 42 of the frame 40 and the inner edge 22 of the peripheral portion 20 substantially coincide. The peripheral portion in this embodiment is the portion of the glass that is shielded within the window frame 40. It should be understood that the size of the peripheral portion on a glass pane could differ for differently sized framed glass units (i.e., some larger window frames cover more areas of a glass pane than other frames) as long as the peripheral portion is the portion of the glass shielded within a particular window frame.

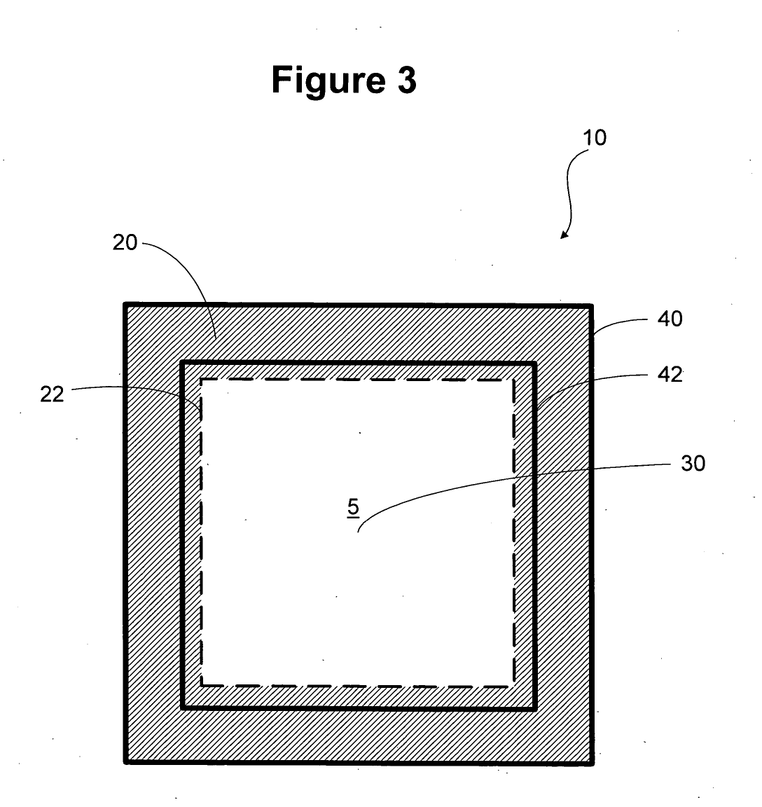

In other embodiments, the peripheral portion comprises the portion of the glass pane that is shielded by a window frame and also an area of glass slightly outside of the framed areas. An embodiment of this type is depicted in FIG. 3, which illustrates a framed glass unit 10 comprising a glass pane 5 and a frame 40. The frame 40 has an inner edge 42 (nearest the central portion 30). The glass pane 5 has a peripheral portion 20 that is heat-treated and a central portion 30 that is not heat-treated. The peripheral portion 20 also has an inner edge 22 (nearer to the central portion 30). In this embodiment, the inner edge of the peripheral portion 22 extends into an area of the glass inwardly from (and is nearer to the central portion 30 of the glass than) the inner edge 42 of the frame 40. In other words, the peripheral portion 20 in this embodiment is larger than the portion of the glass shielded by the frame 40. It is sometimes desirable to have a larger peripheral portion to ensure that all areas of the glass shielded by or in proximity to the frame (i.e., the glass areas subjected to thermal stress) are adequately strengthened to resist thermal breakage. It should be understood that the size of the peripheral portion of a glass pane can differ for differently sized framed glass units (i.e., some larger window frames cover more areas of a glass pane than other frames) as long as the peripheral portion is the portion of the glass pane that is shielded by a window frame and also an area of glass slightly outside of the framed areas.

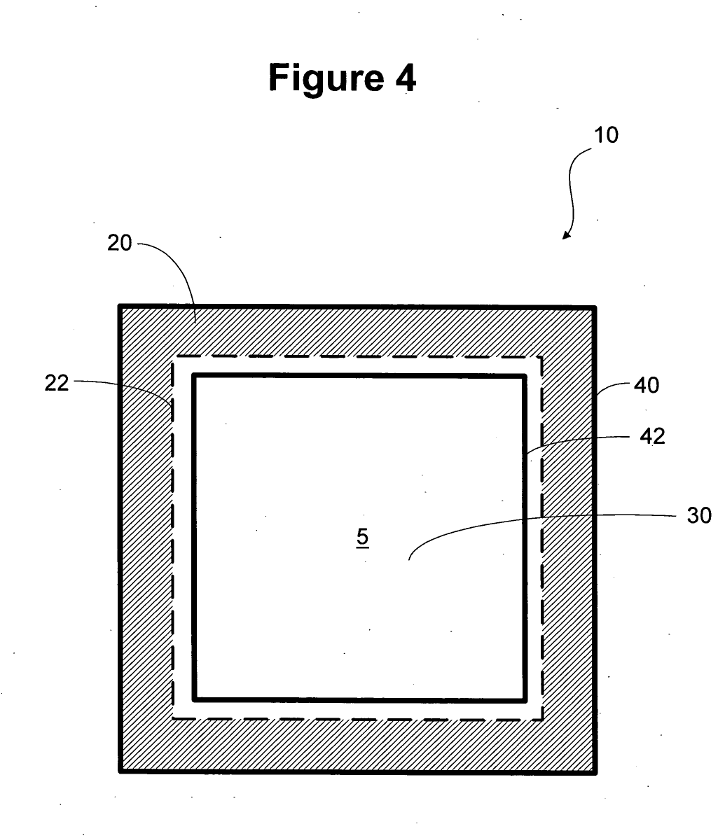

In yet other embodiments, the peripheral portion is the portion of the glass that is shielded by a window frame, but not the entire area of glass shielded by the frame. An embodiment of this type is depicted in FIG. 4, which illustrates a framed glass unit 10 comprising a glass pane 5 and a frame 40. The frame 40 has an inner edge 42 (nearer to the central portion 30). The glass pane 5 has a peripheral portion 20 that is heat-treated and a central portion 30 that is not heat-treated. The peripheral portion 20 also has an inner edge 22 (nearer to the central portion 30). In this embodiment, the inner edge 22 of the peripheral portion 20 covers an area of glass outwardly of (further from the central portion 30 than) the inner edge 42 of the frame 40. In other words, the peripheral portion 20 is smaller than the portion of the glass shielded by the frame 40. In some cases, when the central portion of a glass pane is heated, this heat will often be absorbed by the areas of glass directly inside of the window frame (and adjacent to the central portion). This is particularly true if the glass pane is quite absorptive of solar radiation. Thus, often the only areas needed to be strengthened are those areas that remain cooler while the remainder of the glass is heated. It should be understood that the size of the peripheral portion on a glass pane can differ for differently sized framed glass units (i.e., some larger window frames cover more areas of a glass pane than other frames) as long as the peripheral portion is the portion of the glass that is shielded by a window frame, but not the entire area of glass shielded by the frame.

Therefore, in preferred embodiments, the peripheral portion includes areas of a glass pane in a framed window unit that will remain cooler than other areas of glass when the framed window unit is subjected to solar heating. More preferably, the peripheral portion includes areas of the glass pane that will remain substantially cooler than the other areas of glass when the framed window unit is subjected to solar heating. One of skill in the art will have no trouble determining which portions of a glass pane will remain cooler while other areas are heated due to solar heating. It should be understood that the size of the peripheral portion on a glass pane can differ for differently sized framed glass units (i.e., some larger window frames cover more areas of a glass pane than other frames) as long as the peripheral portion includes areas of a glass pane in a framed window unit that will remain cooler than other areas of glass when the framed window unit is subjected to solar heating.

It should also be understood that in the above embodiments and in the Figures, there is no required abrupt line of demarcation between the peripheral portion and the other portions of the glass. For example, in some cases, the areas where the peripheral portion meets the other glass portions may be graded. That is, with increasing distance from the peripheral portion to the other glass portions, the glass transitions from heat-treated glass to glass that is not heat-treated. In other cases, the areas where the peripheral portion meets the other glass portions may show a more abrupt change from heat-treated glass to glass that is not heat-treated.

The invention also provides methods for heat-treating the peripheral portion of a glass pane to make it resistant to thermal breakage. Generally, the method comprises heat-treating only the peripheral portion of a glass pane while leaving the central portion free of heat treatment. The heat-treating can be accomplished by any conventional heat treatment known in the art, so long as compression is introduced to the surfaces of the peripheral portion. For example, the heat-treating may involve subjecting edges of a glass pane to fire, for example to a blow torch flame. In preferred embodiments, the heat-treating includes applying a laser to the edge of the glass pane to cause the peripheral portion to heat up. Any conventional laser can be used to heat the edges of the glass. Preferably, a heating method will be used that is capable of heating up the peripheral portion to a temperature capable of creating a ΔT upon quenching that will yield an outer surface compressive stress up to about 10,000 psi or a stress level that will resist thermal breakage. In preferred embodiments, the heating method heats up the peripheral portion to a temperature capable of creating a upon quenching that will yield an outer source compressive stress between about 3,500 psi and about 10,000 psi and more preferably between about 3,500 psi and about 7,500 psi. By heat-treating only the peripheral portion of the glass, the central portion remains free of the roll wave effect and other drawbacks commonly associated with tempering and other heat treatments.

In certain embodiments, a method is provided which includes cutting glass into a pane or sheet with a cutting method that causes the cut edges and peripheral portion of the pane to heat up and then quenching the peripheral portion with a cold quenching medium. One of skill in the art will understand that any cutting method can be used so long as the peripheral portion of the pane is heated. Preferably, a cutting method will be used that is capable of heating up the peripheral portion extensively, desirably to a temperature well above the glass transition temperature of the glass pane. More preferably, a cutting method will be used that is capable of heating up the peripheral portion to a temperature capable of creating a ΔT upon quenching that will yield an outer surface compressive stress up to about 10,000 psi or a stress level that will resist thermal breakage. In preferred embodiments, the cutting method heats up the peripheral portion to a temperature capable of creating a upon quenching that will yield an outer source compressive stress between about 3,500 psi and about 10,000 psi and more preferably between about 3,500 psi and about 7,500 psi. This heating and quenching serves to strengthen the peripheral portion so that it is resistant to thermal breakage.

In preferred embodiments, the cutting method comprises cutting the glass with a laser. When a laser cuts glass, for example, the heat from the laser causes the glass to heat up extensively. Any conventional laser apparatus can be used to cut the glass, or in embodiments where the glass is previously cut, any conventional laser can be used to heat the edges of the glass. While the specific type of laser apparatus used is beyond the scope of the invention, a brief explanation of lasers used with glass panes follows.

When laser cutting a pane of glass, a laser beam, e.g., commonly an infrared laser beam, is applied to the glass along the line of cut. Some laser beams are capable of cutting the glass throughout its thickness in one step. Other laser beams simply create a scored line on the surface of the glass, wherein the glass is later mechanically separated along this scored line. The scored line helps to create a straight, clean break during mechanical separation.

There are generally two types of lasers currently used for glass cutting. One laser comprises a CO₂ laser. The CO₂ laser typically emits laser light in the deep infrared wavelength range at about 10.6 μm at a power of up to about 40,000 watts, depending on the laser. The laser radiation is typically absorbed almost entirely at the surface of the glass, where it is then converted to heat. Another laser comprises an Nd:YAG laser beam. The Nd:YAG laser typically emits a laser light in the near visible wavelength range at about 1.06 μm at a power of up to about 4,000 watts. The Nd:Yag laser radiation is typically absorbed throughout the entire thickness of the glass, where it is converted to heat. Depending on the glass composition, between about 10% and about 20% of the laser light is absorbed during one Nd:Yag laser beam passage through the glass. To obtain a uniform high temperature at a glass edge during cutting, it may be desirable to heat the top and bottom surfaces of the glass edge with more than one laser.

Lasers can generally be operated in a continuous wave or pulsed wave mode. A pulsed mode is often used to provide rapid vaporization of the material in contact with the laser beam but without heating the surrounding area. In order to accomplish this, the power levels used with a pulsed wave laser beam is often times much higher than the power levels used with a continuous wave laser beam. Therefore, in cases where it is desirable to cut glass, it may be desirable to use a pulsed laser beam and/or use higher power levels. In cases where it is desirable to only heat the edge of a glass pane, it may be desirable to use a continuous wave laser beam and/or lower power levels. Those of skill in the art can select an appropriate laser cutter and vary the power levels and/or types of laser beams used in order to either cut a glass sheet into a pane or to merely heat the edge of a glass pane.

One suitable laser cutting apparatus suitable for use with the invention includes the DLC 600 Laser Cutter, available from Schott Advanced Processing, a corporation located in Yonkers, N.Y. The DLC 600 Laser Cutter employs a CO2 laser beam at a power of between 25-250 watts. When it is desired to use a laser apparatus to cut glass, a higher power, e.g., 100 watts can be used to implement a full cut into the glass. When it is desired to use a laser apparatus to merely heat the edge of a glass, a lower power, e.g., less than about 100, watts can be used to heat the glass edge. The laser beam can also be moved along a glass at a speed which causes the glass to heat up to a desired temperature. For example, if desiring to heat the glass edges to a temperature of between about 1,200° F. to about 1,300° F., the laser would be moved along the edges at a speed of about 36-60 inches per minute.

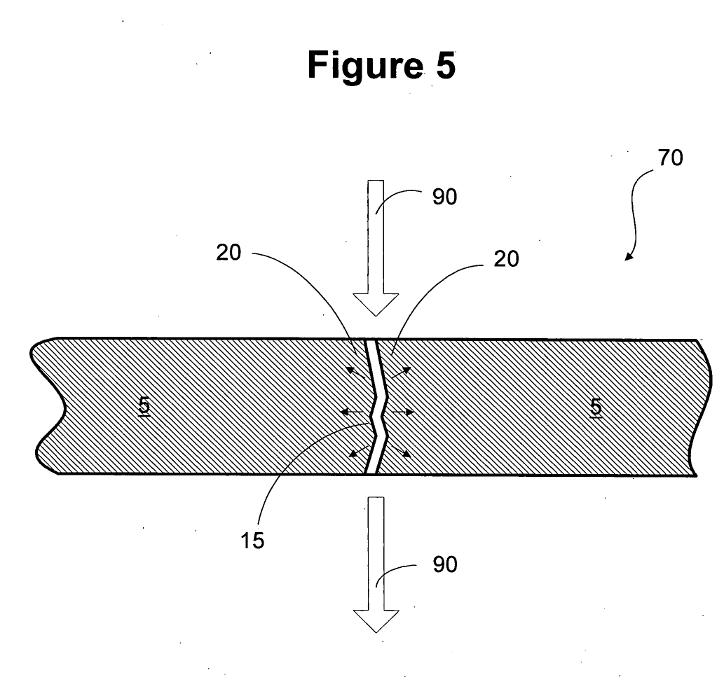

A preferred method of laser cutting glass into glass panes is illustrated in FIG. 5. FIG. 5 shows a large piece of glass 70 that is cut into glass panes 5. A laser beam apparatus (not shown) emits a laser beam 90 that penetrates the glass piece 70 along lines of cut 15. The line of cut 15 does not necessarily have to be a straight line, and any line of cut will be suitable. Some of the laser beam 90 transmits through the line of cut 15 whereas some of the laser beam energy is absorbed into the surrounding peripheral areas 20 of each glass pane 5.

In certain embodiments, the method of the invention further includes either scoring the glass prior to heating or pre-heating the peripheral areas before cutting the glass or post-heating the peripheral areas after cutting the glass. While the cutting method alone preferably provides sufficient heating along the peripheral areas, in many cases it may be desirable to have additional heating. For example, additional heating may be desirable with a glass pane destined for use in a frame unit having a large frame covering more areas of the glass. In this case, the peripheral areas need to be larger, so additional heating may be helpful to ensure that the entire desired peripheral area is adequately heated.

The quenching of the peripheral area of a glass pane with a cold medium can be accomplished using cold mediums known in the art. The cold quenching medium creates a sufficient ΔT between the inner central and exterior surfaces of the peripheral areas to provide the peripheral strengthening. In certain embodiments, the quenching reduces the temperature of the exterior surfaces of the peripheral areas so that a ΔT of at least 10° F. is provided or a ΔT high enough to cause the glass to resist thermal and bending stresses. In other embodiments, the quenching reduces the temperature of the exterior surfaces of the peripheral areas so that a ΔT up to about 200° F. is provided. In preferred embodiments, the quenching reduces the temperature of the exterior surfaces of the peripheral areas so that a ΔT in the range of about 70° F. to about 150° F. is provided.

The ability to obtain a particular or desired ΔT upon quenching depends at least partially on the thickness of the glass pane, the applied temperature, the speed of the laser and the temperature of the quenching media. It is generally more difficult to obtain a desired ΔT with thinner panes of glass. This is because, upon quenching, heat is readily conducted from the center of the glass to the surface of thin glass panes. On the other hand, it is much easier to establish a ΔT with thicker glass panes because the thicker glass prevents heat from being easily conducted from the center to the surface.

Glass panes are often quenched using cold air as a cooling medium. Thus, in certain embodiments, the peripheral area of the glass pane is quenched using a cold air medium. Cold air is particularly desirable for use as quenching medium for quenching thicker glass panes. For example, it has been found that cold air works well for quenching glass panes having a thickness of about 2.2 mm (0.09 inches) or more. Thus, in particular embodiments, the invention comprises cutting glass having a thickness of about 2.2 mm or more into a pane with a cutting method that causes the cut edges and peripheral portion of the pane to heat up extensively and then quenching the peripheral portion with a cold air stream. The cutting method preferably comprises laser cutting. Likewise, the peripheral portion may either be pre-heated before cutting or post-heated after cutting to ensure that the glass is heated at a sufficient point above its transition temperature.

However, cold air has been found to be a less sufficient quenching medium for use with thinner glass panes. Quenching mediums such as carbon dioxide and liquid nitrogen produce desirable results with thinner glass panes as the ability to create the desired ΔT is significantly easier with these low temperature gases. For example, it has been found that carbon dioxide or liquid nitrogen vapor works better than cold air for quenching glass panes having thicknesses of about 2.2 mm (0.09 inches) or less. Thus, in certain embodiments, the peripheral area of the glass pane is quenched using a carbon dioxide or a liquid nitrogen vapor. In particular embodiments, the invention comprises cutting glass having a thickness of about 2.2 mm or less into a pane with a cutting method that causes the cut edges and peripheral portion of the pane to heat up extensively and then quickly quenching the peripheral portion with carbon dioxide or liquid nitrogen vapor. The cutting method preferably comprises laser cutting. Likewise, the peripheral portion may either be pre-heated before cutting or post-heated after cutting so ensure that the glass is heated at a sufficient point above its transition temperature.

In certain embodiments, the peripheral portions of the glass panes are quenched after the glass has been cut into a separate glass pane. In this case, the quenching medium is not applied until the glass pane has been completely separated by the cutting method. In other embodiments, the peripheral portions of a glass pane are quenched while the glass is being cut into separate panes. In this case, the quenching medium, such as a cold jet of air, is applied directly following the path of cut by a laser or other cutting method. Here, the quenching takes place as the glass pane is being cut rather than after the entire pane has been cut.

In certain embodiments, the invention also includes the steps of determining the amount of compression desired for the surfaces of the peripheral portion and heating the peripheral portion so that a ΔT is established that will create the desired amount of compression upon quenching. Generally, the compressive stress at the outer surfaces of a glass pane increases by about 50 psi for each 1° F. of ΔT between that surface and the center of the glass pane provided the complete glass pane or are to be heat treated is above the glass transition temperature. Thus, if it is desirable to obtain a compressive force of 5,000 psi along the peripheral surface of a particular glass pane, a ΔT of about 100° F. should be established. Again, the glass must be heated to a temperature exceeding the glass transition temperature. So, if the glass transition temperature of a particular glass pane is 983° F. and it is desirable that the peripheral portion have an exterior surface compression of 5,000 psi, then the peripheral portions should be heated to at least 983° F. plus 100° F., or 1083° F.

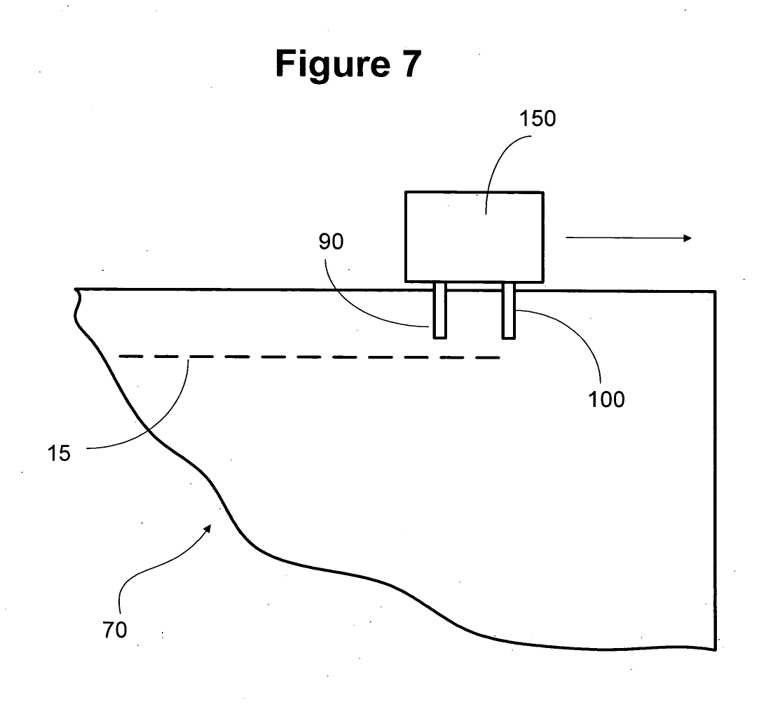

The present invention also provides an edge treatment apparatus for edge treating glass panes in accordance with the embodiments described in the invention. FIG. 7 illustrates a preferred edge treatment apparatus 150. The apparatus 150 comprises a laser cutting nozzle 90 and a quenching nozzle 100. The apparatus 150 can be moved over (or beneath) a large piece of glass 70 along the line of cut 15. The laser cutting nozzle 90 emits a laser beam and the quenching nozzle 100 emits a quenching medium. The nozzle 90 can be configured to emit a conventional laser beam, such as a CO2 laser beam or a Nd:YAG laser beam. The nozzle 100 is configured to emit a conventional quenching medium, such as cold air, CO2 or liquid nitrogen vapor. As the apparatus 150 is moved along the line of cut 15, the glass is first cut by a laser beam emitted from nozzle 90 and then immediately quenched by a quenching medium emitted from nozzle 100. The quenching medium emitted from nozzle 100 should impart compressive stresses into the areas adjacent to the line of cut 15. The apparatus 150 allows for both the laser cutting and quenching to be accomplished in one pass over a piece of glass using a single device.

While certain preferred embodiments of the invention have been described, it should be understood that various changes, adaptations, and modifications may be made therein without departing from the spirit of the invention and the scope of the appended claims.

What is claimed is:

1. A glass pane having a central portion, and a peripheral portion extending inwardly from and bounded by edges of the pane, the peripheral portion being heat-treated to increase its resistance to breakage, and said central portion being not heat-treated.

2. The glass pane of claim 1 wherein said heat-treated peripheral portion has a surface compression up to about 10,000 psi.

3. The glass pane of claim 1 wherein said heat-treated peripheral portion has a surface compression between about 3,500 psi and about 10,000 psi.

4. The glass pane of claim 1 wherein said heat-treated peripheral portion has a surface compression between about 3,500 psi and about 7,500 psi.

5. The glass pane of claim 1 wherein said heat-treated peripheral portion comprises an area of the glass pane not subjected to solar heating.

6. A framed glass unit comprising a glass pane and a frame, the glass pane having a central portion and a peripheral portion, the peripheral portion alone being heat-treated to increase its resistance to breakage, the frame shielding at least part of the peripheral portion of the pane.

7. The unit of claim 6 wherein said heat-treated peripheral portion has a surface compression up to about 10,000 psi.

8. The unit of claim 6 wherein said heat-treated peripheral portion has a surface compression between about 3,500 psi and about 10,000 psi.

9. The unit of claim 6 wherein said heat-treated peripheral portion has a surface compression between about 3,500 psi and about 7,500 psi.

10. The unit of claim 6 wherein said heat-treated peripheral portion comprises the entire portion of the glass pane shielded by the frame.

11. The unit of claim 6 wherein said heat-treated peripheral portion comprises the entire portion of the glass pane shielded by the frame and a portion of the glass pane not shielded by the frame.

12. The unit of claim 6 wherein said heat-treated peripheral portion comprises a portion of the glass pane shielded by the frame but not the entire portion of the glass pane shielded by the frame.

13. A method of forming a glass pane suitable for use as a window, door or the like, comprising:
a. providing a glass pane that has not been heat-treated,
b. laser cutting said pane to provide a glass pane having a heated peripheral portion bounded by edges of the pane and extending inwardly from such edges,
c. quickly quenching the heated peripheral portion to heat treat it, leaving the pane with a central portion that is not heat-treated.

14. The method of claim 13 wherein the quenching comprises reducing the surface temperature of the peripheral portion sufficiently to provide a ΔT between the surface and the interior of the pane of at least about 10° F.

15. The method of claim 14 wherein said ΔT is up to about 200° F.

16. The method of claim 14 wherein said ΔT is in the range of about 70° F. to about 150° F.

17. The method of claim 13 further including framing the resulting glass pane with a frame having a shielding portion extending inwardly from the pane edges so that the heat-treated peripheral portion comprises the entire portion of the glass pane shielded by the shielding portion.

18. The method of claim 13 further including framing the resulting glass pane with the frame having a shielding portion extending inwardly from the pane edges so that the heat-treated peripheral portion comprises the entire portion of the glass pane shielded by the shielding portion a portion of the glass pane not shielded by the shielding portion.

19. The method of claim 13 further including framing the resulting glass pane with the frame having a shielding portion extending inwardly from the pane edges so that the heat-treated peripheral portion comprises the a portion of the glass pane shielded by the shielding portion but not the entire portion of the glass pane shielded by the shielding portion.

20. A method of forming a glass pane suitable for use as a window, door or the like, comprising:
providing glass that has not been heat-treated;
cutting the glass into a pane having a peripheral portion and a central portion, the cutting causing the peripheral portion of the glass pane to heat up;
quenching only the peripheral portion with a cold quenching medium to heat treat it, while leaving the central portion free of heat treatment.

21. The method of claim 19 wherein the cutting comprises cutting the glass with a laser.

22. The method of claim 19 wherein the quenching comprises reducing the surface temperature of the peripheral portion sufficiently to provide a ΔT between the surface and the interior of the pane of least about 10° F.

23. The method of claim 22 wherein said ΔT is up to about 200° F.

24. The method of claim 22 wherein said ΔT is in the range of about 70° F. to about 150° F.

25. The method of claim 20 wherein the quenching comprises quenching with a cold air medium.

26. The method of claim 20 wherein the quenching comprises quenching with a carbon dioxide medium.

27. The method of claim 20 wherein the quenching comprises quenching with a liquid nitrogen vapor.

28. The method of claim 20 further including applying additional heat to the peripheral portion of the glass pane before quenching.

29. The method of claim 20 further including framing the resulting glass pane with a frame having a shielding portion extending inwardly from the pane edges so that the heat-treated peripheral portion comprises the entire portion of the glass pane shielded by the shielding portion.

30. The method of claim 20 further including framing the resulting glass pane with the frame having a shielding portion extending inwardly from the pane edges so that the heat-treated peripheral portion comprises the entire portion of the glass pane shielded by the shielding portion a portion of the glass pane not shielded by the shielding portion.

31. The method of claim 20 further including framing the resulting glass pane with the frame having a shielding portion extending inwardly from the pane edges so that the heat-treated peripheral portion comprises the a portion of the glass pane shielded by the shielding portion but not the entire portion of the glass pane shielded by the shielding portion.

32. A method of forming a glass pane suitable for use as a window, door or the like, comprising:
providing a glass pane that has not been heat-treated, the glass pane having a peripheral portion and a central portion;
heating only the peripheral portion, causing the peripheral portion to heat up;
quenching only the peripheral portion with a cold quenching medium to heat treat it, while leaving the central portion free of heat treatment.

33. The method of claim 32 wherein the heating comprises applying a laser to the edge of the glass pane to cause the peripheral portion to heat up.

34. The method of claim 32 wherein the quenching comprises reducing the surface temperature of the peripheral portion sufficiently to provide a ΔT between the surface and the interior of the pane of least about 10° F.

35. The method of claim 34 wherein said ΔT is up to about 200° F.

36. The method of claim 34 wherein said ΔT is in the range of about 70° F. to about 150° F.

37. The method of claim 32 wherein the quenching comprises quenching with a cold air medium.

38. The method of claim 32 wherein the quenching comprises quenching with a carbon dioxide medium.

39. The method of claim 32 wherein the quenching comprises quenching with a liquid nitrogen vapor.
